(19) United States
(12) Patent Application Publication
(10) Pub. No.: US 2009/0016948 A1
(43) Pub. Date: Jan. 15, 2009

(54) Carbon and fuel production from atmospheric CO2 and H2O by artificial photosynthesis and method of operation thereof

(76) Inventor: Edgar D. Young, Cashiers, NC (US)

Correspondence Address: MYERS & KAPLAN;INTELLECTUAL PROPERTY LAW, L.L.C., CUMBERLAND CENTER II, 3100 CUMBERLAND BLVD , SUITE 1400, ATLANTA, GA, 30339, US

(21) Appl. No.: 12/214,728

(22) Filed: Jun. 20, 2008

Related U.S. Application Data
(63) Continuation-in-part of application No. 11/827,814, filed on Jul. 12, 2007.

(51) Int. Cl. C01B 31/00

(52) U.S. Cl. 423/414

(57) ABSTRACT

The present invention relates generally to reduction of atmospheric carbon dioxide and to production of carbon therefrom for further use as, for example, fuel and morespecifically, to the process of dissolving atmospheric carbon dioxide into a suitable preferably alkali metal salt flux for electrolysis thereof into carbon and oxygen.

### TECHNICAL FIELD

This application is a continuation-in-part application to Ser. No. 11/827,814, filed on Jul. 12, 2007.

The present invention relates generally to fuel production, and more specifically, to carbonaceous fuel production by means of utilization of atmospheric carbon dioxide and water by “artificial photosynthesis”, as defined herein, and methods of operation thereof.

### BACKGROUND OF THE INVENTION

The current state of affairs regarding carbon dioxide and its close relationship to global warming has reached an all time high. Many responsible sources contend that the condition of the earth's atmosphere is such that, in order to avoid the predicted dire consequences of global warming affects, removal of a portion of the existing, and increased, carbon dioxide from the atmosphere (in a preferred amount approximating one billion tons annually for about a decade) is needed.

The methods of the present invention meet these drastic requirements and also further provide a substantial environmental benefit in which the inventive processes hereof would require no additional energy from present earth-based fuel sources. Furthermore, the present processes produce useful and essential fuels which can be further beneficially utilized. These substantial advantages promise to usher in an energy and environmental management era of efficient and accurate climate control engineering. These results could be accomplished using known but presently unused control theories, together with and in combination with reasonable open-loop models for short term and extended climatic change. Moreover, and despite the long-felt need in the art for the salutary benefits provided by the several embodiments of the present invention as disclosed and claimed herein, those skilled in the art have not formulated, or discovered, or utilized these most propitious solutions.

Furthermore, the product fuels produced by means of the methods of the present invention can be stored compactly and efficiently at the site of their production, and thus resulting in but minimal environmental impact, and with no necessity to transport hazardous materials. As a matter of yet further efficiency, the required energy for use in the methods of the present invention could be harvested from solar collecting or by wind powered or geothermal means within the vicinity of local processing plants.

The economics of preferred embodiments of the inventive processes hereof are such that the cost of supplying energy for customer use, including electric auto transportation plus climate control storage, could additionally allow for commonly realized profit margins, while maintaining costs at the levels traditionally charged to a customer. Furthermore, when climate levels have become stabilized according to the methods of the invention hereof, profit margins would rise substantially and/or customer costs could be substantially reduced.

A chemical process known to those skilled in the art for isolating carbon by utilizing CO₂ comprises the oxidation through burning of shredded magnesium inside a split block of frozen CO₂. The Carbon thus produced appears in sizeable chunks mixed together with chunks of magnesium oxide ash, and whereupon, the CO₂ and MgO can be facilitatively separated by means of shaking, combined with crushing and shifting. By these means this separation process accordingly utilizes differences in the density of the CO₂ and MgO components of the mixture.

One further method for performing combustion of magnesium in CO₂ gas has been performed by the University of North Carolina, and wherein a ribbon of magnesium is burned in a chamber of suitable and selected size, thereby producing flecks of carbon and oxide as collected upon the chamber walls, and wherein particle size and product separation are shown to comprise functions of the magnesium preparation, combustion chamber size and the temperature profile maintained within.

However, and as the combustion of magnesium is extremely exothermic, it is therefore clear that substantial advantages appear when excess heat from such a reaction chamber is harnessed by means of a heat engine cycle, resulting in the supplying of electric power to augment an input electric grid. Wherefore, these considerations may impose constraints upon the combustion chamber design under the corresponding embodiment hereof, as well as upon the separation process.

Yet further, the process for producing solid carbon can be reduced to a secondary sub-process for isolating CO₂ from the air, followed by a secondary combustion process utilizing the crucial fact that CO₂ supports combustion of Magnesium metal. Finally, a process has been provided for separating carbon produced from the magnesium oxide ash, and processes for isolating CO₂ include freezing CO₂ ice or the use of selective solvents. These various aspects of the prior art methods necessitate different combustion chamber design requirements and physical separation requirements.

In one yet further prior art method, magnesium is then recovered from the magnesium oxide ash using electrolysis, as oxygen is expelled therefrom. As set forth hereinbelow, at the end of the essentially cyclic processes of the present invention, all byproducts of the process may be returned to their initial status.

Common procedures for converting MgO to Mg, converting first to MgCl₂ by use of hydrochloric acid (releasing water) and thereafter decompose the magnesium chloride by electrolysis in a molten salt electrolyte. Chlorine (given off at the anode) is combined with Hydrogen (from electrolysis of water) to recover Hydrochloric Acid.

Accordingly, the inventive methods now include two major preferred embodiments as preferred processes hereof—one being as described, supra, and a further embodiment wherein carbon dioxide may be reduced directly in one step to carbon by electrolysis.

Thus such second major embodiment of the present invention includes the desirable feature of eliminating the requirement for an intermediate metallic oxide formation, which is stringly exothermic, and thus to meet the objectives of the present invention with potentially greater efficiency and yet greater simplicity.

In summary, various aspects of the problem of atmospheric CO₂ management have been addressed in previous inventions. However, none have provided the free selection of carbonaceous fuels to be produced efficiently and in a substantial capacity. Accordingly, the beneficial aspects of the present invention include the provision of processes for producing carbonaceous fuel from a first sub-process of isolating CO₂ from the atmosphere and a second sub-process for recovering magnesium.

### BRIEF SUMMARY OF THE INVENTION

The present invention relates generally to reduction of atmospheric carbon dioxide and to fuel production, and more specifically, to carbonaceous fuel production by means of utilization of atmospheric CO₂ and H₂O by “artificial photosynthesis”, as defined herein and methods of operation thereof.

The inventive methods of the present invention may preferably comprise in the main process sub-processes for (a) producing carbon, and (b) for recovering magnesium. The production of carbon of step (a) may be sub-divided further into tertiary processes for isolating CO₂, for producing carbon, and for separating from byproducts or ash. Yet additionally, the processes hereof may utilize the Fischer-Tropsch process as an option for producing a variety of hydrocarbon fuels.

In a second an further improved embodiment, carbon itself has been found to be utilized as a metal in the context of the present invention, and accordingly carbon dioxide may be electrolyzed directly into carbon and oxygen; provided, however that an electrolyte of molten metallic salts could be found which would dissolve carbon dioxide. Such molten salts that have the required relationship with carbon dioxide have now been discovered, as disclosed amore particularly and as claimed herein.

The present invention may be better understood by those skilled in the art, but not unnecessarily limited, with regard to and by reference to the following detailed description of the drawing, the detailed description of preferred embodiments, the appended clams and the accompanying drawings.

### BRIEF DESCRIPTION OF THE DRAWINGS

Accordingly, the present invention may be better understood by those skilled in the art through consideration of, and reference to, the following Figures, viewed in conjunction with the Detailed Description of the Preferred Embodiment referring thereto, in which like reference numbers throughout the various Figures designate like structure and in which:

FIG. 1 shows the first major embodiment of the present invention, and wherein a breakdown of the main process into sub-processes for producing carbon and for recovering magnesium;

FIG. 2 shows the first major embodiment of the present invention, and wherein the breakdown of carbon production as a process into secondary processes for isolating carbon dioxide, producing carbon, and separating from byproducts or ash; and

FIG. 3 shows the first major embodiment of the presemt invention, and wherein an an extension of the main process (1) utilizing the Fischer-Tropsch process as an option for producing a variety of hydrocarbon fuels;

FIG. 4 shows a variant of the first embodiment of the present invention, and wherein inventive modifications to the prior art Solid Oxide Membrane (or “SOM”) process are adapted to combine the oxidation of magnesium and reduction of carbon dioxide, together with the recovery of the metal and the carbon, into a single continuously acting process; and

FIG. 5 shows a species of the second major embodiment of the present invention, wherein a further application of the SOM-type process has been adapted to the principles hereof to provide the direct reduction of carbon dioxide to carbon.

It is to be noted that the figures presented herein are intended soley for the purpose of illustration and that they are, therefore, meither desired to limit nor intended to limit the present invention to any or all of the details of construction or method as shown, except insofar as they may be deemed essential to the claimed invention.

### DETAILED DESCRIPTION OF THE INVENTION

In describing preferred embodiments of the present invention illustrated in the Figures, specific terminology may be employed for the sake of clarity. The present invention, however, is not intended to be limited to the specific terminology so selected, and it is to be understood that each specific element or step hereof includes all technological equivalents that operate in a similar manner to accomplish a similar purpose.

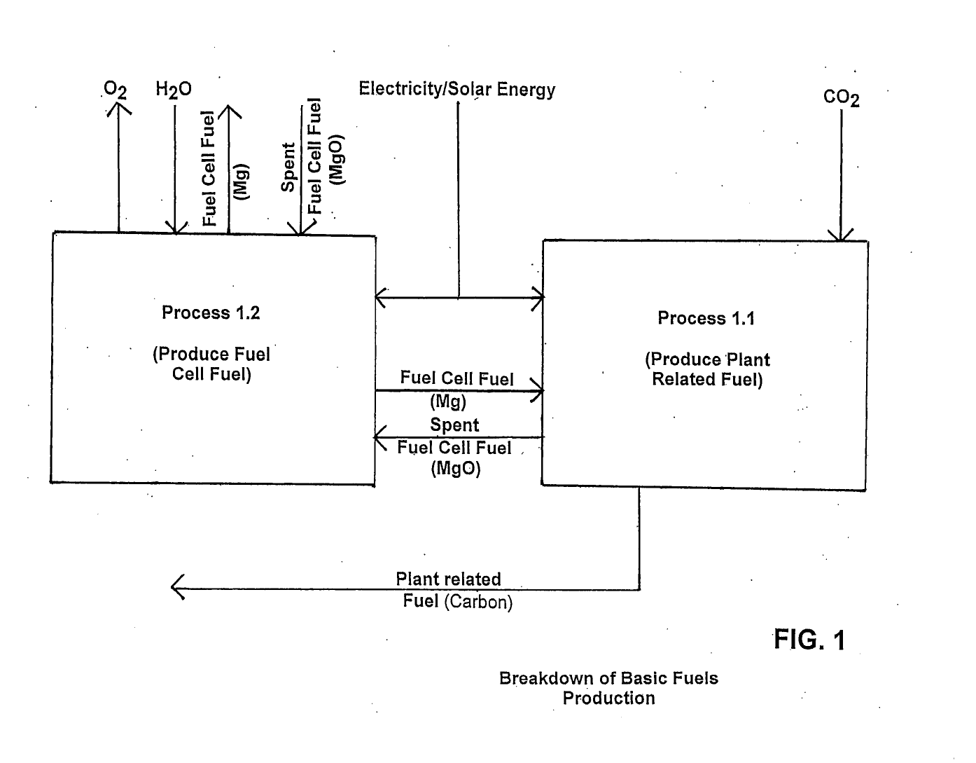

As set forth above, FIGS. 1-4 depict a first major embodiment of the present invention, directed to reducing carbon from carbon dioxide (extracted from air) by oxidizing metal such as Magnesium in an atmosphere of carbon dioxide, recovering the carbon, and then reducing the resulting metal oxide back to elementhal metal.

FIG. 1-5 depicts a second major form of embodiment of the present invention, directed to the electrolysis of carbon dioxide directly into carbon and oxygen using an electrolyte of molten metallic salts which dissolve carbon dioxide.

As chosen for purposes of illustration, FIG. 1 shows a breakdown of the main process into sub-processes for producing carbon and for recovering magnesium, and further providing schematic details of Process 1.1, and in which the input there comprises the use of CO₂ and magnesium or other similar metal, and the output therefrom constitutes metallic oxide and plant related fuel in the form of carbon. The means used therein preferably comprise electricity, in the form of solar energy, wind poser of geothermal means.

Process 1.2 of the inventive methods hereof as illustrated schematically in FIG. 1 utilizes in preferred embodiments thereof as input H₂O and spent fuel cell fuel in the preferred form of magnesium oxide, and produces as output oxygen and fuel cell fuel in the preferred form of elemental magnesium, and again using therein energy means preferably comprising electricity, solar energy, wind power, or geothermal means.

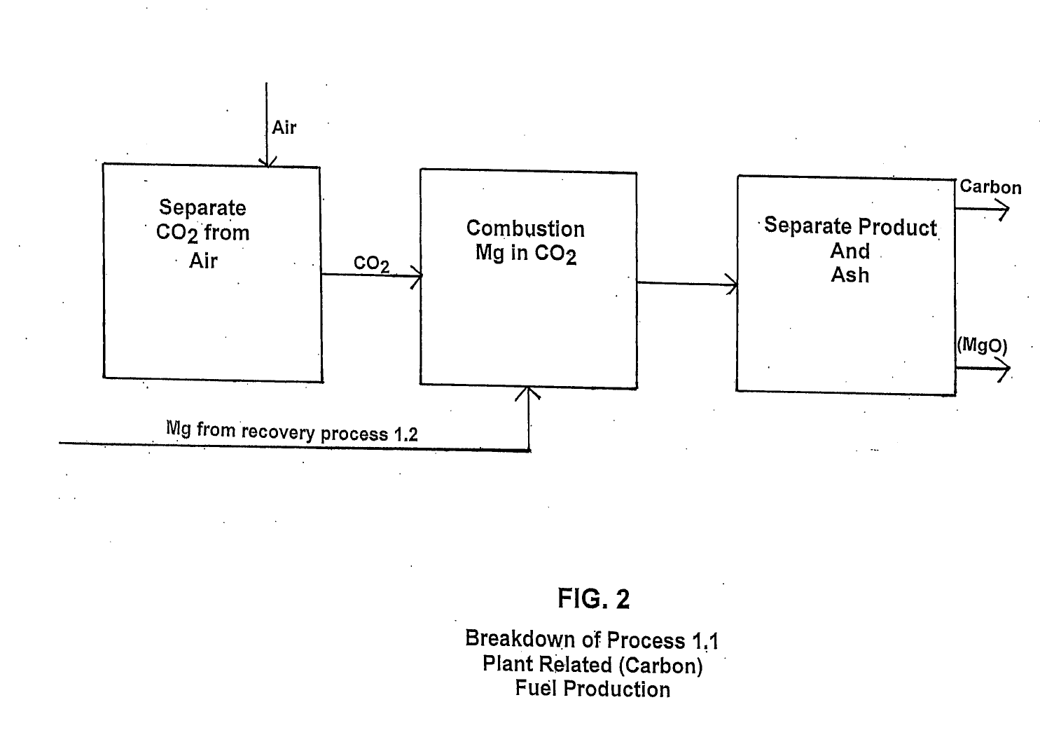

Illustrated schematically in FIG. 2 is a more detailed breakdown of process 1.1 of FIG. 1, supra, and is directed to carbon production as a process into secondary processes for isolating CO₂, producing carbon, and separating from byproducts or ash, and constitutes the sub-steps of:

1. Separating CO₂ from air, and with air as an input, and carbon dioxide as an output;

2. Combustion of magnesium in carbon dioxide, and utilizing magnesium from the recovery process of Process 1.2, supra; and

3. Separating the desire product from the ash and with carbon and magnesium oxide as outputs.

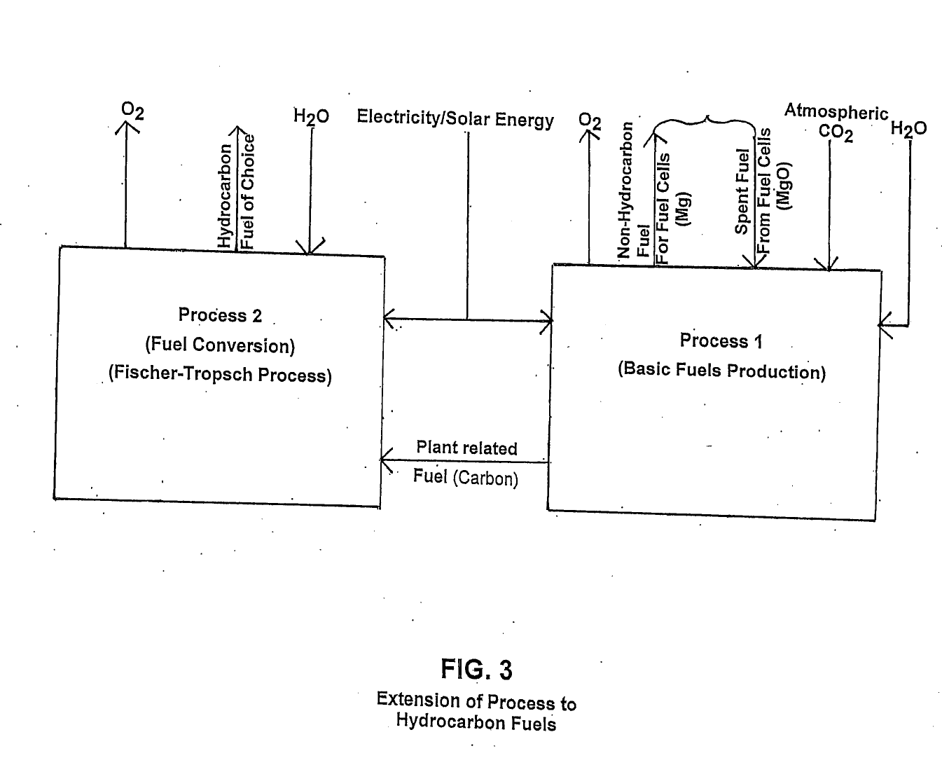

FIG. 3 schematically illustrates an extension of the main process to the basic formation of hydrocarbon fuels, and having an input of water and atmospheric carbon dioxide together with the fuel cell fuel, in the preferred form of magnesium oxide, and having as output non-hydrogen fuel for the fuel cell in the preferred form of magnesium and plant related fuel in the form of carbon, and also the energy used therein preferably comprises electricity, in the form of solar energy, wind power or geothermal means. In sub-step 2 of FIG. 3, the fuel conversion is accomplished by means of the Fischer-Tropsch Process, and wherein the input is water and Plant related fuel, in the form of carbon, and the energy used therein preferably comprises electricity, in the form of solar energy, wind power or geothermal means.

In greater detail, embodiments of the present invention may be beneficially utilized to materially reduce the above-mentioned disadvantages, deficiencies and detriments of prior art systems and simultaneously to address the long-felt need for increased fuel production—and more specifically, carbonaceous fuel production—by means of atmospheric CO₂ and H₂O by “artificial photosynthesis” and a method of operation thereof. Accordingly, the preferred embodiments of the present invention are directed towards methods for producing carbonaceous fuel from first sub-process of isolating CO₂ from air, a second sub-process for producing carbon by burning magnesium and a third sub-process for recovering magnesium.

Hence, preferred embodiments of the present invention utilize atmospheric carbon dioxide and water to produce a variety of carbonaceous fuels. Advantageously, the only energy required for the inventive processes hereof is electrical energy, which may be obtained by solar energy means. This process may be thus defined herein, and as used herein, as “artificial photosynthesis”. The “artificial photosynthesis” processes of the present invention can be operated to produce substantially is no byproducts. In alternative preferred embodiments, the processes of artificial photosynthesis can optionally be operated to provide additional metallic-type fuels, which accordingly may be considered to be optimal for fuel cell applications.

In somewhat greater detail, preferred embodiments of the inventive processes hereof comprise a first sub-process for producing carbonaceous fuel (carbon) from atmospheric CO₂ and/or from a metallic fuel cell system utilizing magnesium, and a second process for recovering magnesium from magnesium oxide produced as a byproduct or ash from the first sub-process, with the use of water as a catalyst and oxygen as a byproduct -- as in natural photosynthesis, but however utilizing man-directed means.

The second sub-process is essentially for the purpose of recovering magnesium. However, in further preferred embodiments of the methods of the present invention, metals other than magnesium that will readily and rapidly oxidize may be utilized in these aspects of the methods hereof. These metal recovery processes can in certain preferred embodiments be electrolytic, which in essence would require electrical energy. Among the most efficient mechanisms for providing this electrical energy include solar power.

Conceptually, if magnesium were considered to be “fuel” for a fuel cell, magnesium oxide would thus be defined as a byproduct or an “ash” within a spent fuel cell. Excess products such as such ashes can accordingly be reprocessed in the second sub-process to recover magnesium as “fuel” for the yet further use with in the fuel cell.

Yet further, utilizing the carbon fuel from the second sub-process produces a variety of hydrocarbon fuels. These are produced by feeding carbon into a catalytic process to synthesize hydrocarbons and their oxygen derivatives by the controlled reaction of hydrogen and carbon monoxide.

Again the conventional process for converting MgO to magnesium is to first convert MgO to MgCl₂, using HCI, an alternative embodiment hereof may utilize a magnesium/nickel chromium battery (with the magnesium cathode replaced with magnesium oxide). Thereafter, a reverse charge voltage would be applied which would transport chloride ions to the cathode and produce nascent chlorine. Thereupon, hydrogen from electrolysis of water may be introduced at the electrode to react with the chlorine, and as a result would thereafter react with magnesium oxide to produce magnesium chloride and thereby recover water. When the voltage is reversed, magnesium is recovered at the cathode and the chlorine goes back to storage at the anode. A benefit of this process would be the fact that transport of the chlorine gas would not be necessary.

Thus, and in summary, but without limitation, in the first major embodiment of the present invention, carbon is reduced from carbon dioxide (extracted from air) by first reducing carbon dioxide to carbon by oxidizing metal such as Magnesium in an atmosphere of carbon dioxide, collecting the carbon, and then reducing the resulting metal oxide back to elemental metal using variants of the standard recovery process.

More recently it has been discovered that metals such as magnesium can be recovered by a simpler more direct solid oxide membrane (SOM) process, an example of which is set forth in Krishnan, Lu, and Pal “Solid Oxide Membrane Process . . . ” Metallurgical and Materials Transactions Volume 36B August 2005-463-473.

An SOM process may be substituted for the more convential metal recovery process. To do so eliminates the requirement to use water as a catalyst.

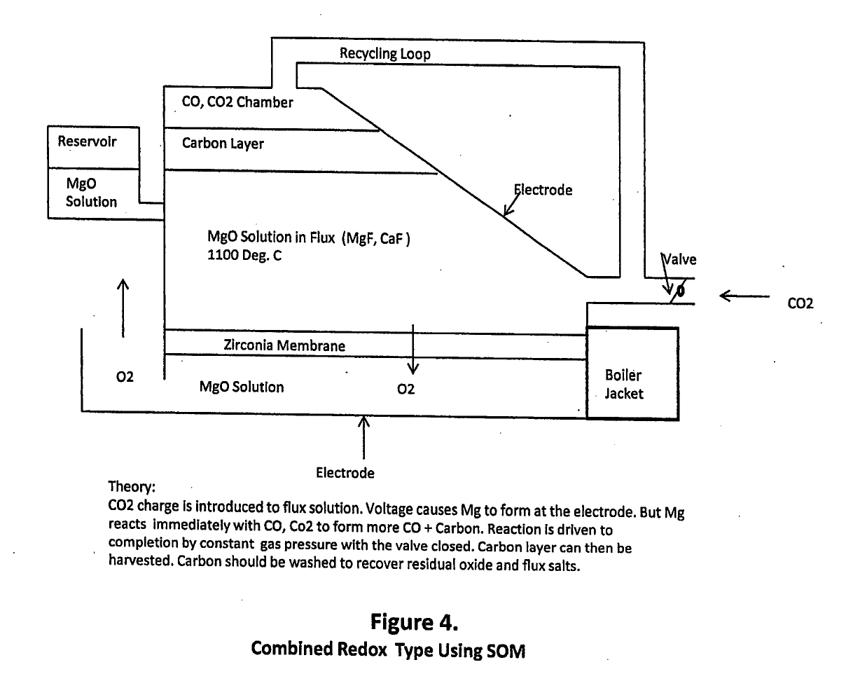

As shown in FIG. 4, an SOM process may further be applied in order to combine the reduction of carbon dioxide, oxidation of the active metal, and recovery of the active metal into a single and continuously acting process as an exemplary process of preferred embodiments of the present invention.

A pressurizable chamber which can sustain pressures greater than one atmosphere is provided. Thereafter and similar to other preferred embodiments, carbon dioxide together with the carbon monoxide produced by the process thereof are collected and maintained for use in the process. A renewable source of magnesium oxide is further provided, and such magnesium oxide is charged into the molten flux, preferably comprising a molten alkalized salt, and is contained within the action chamber.

As with other embodiments, a cathode is contacted with the flux and a non-consumable anode, one example of which is set forth in U.S. Pat. No. 4,956,068, is provided and placed in communication with the flux. A suitable membrane an example of which is referenced, supra, is also disposed in communication with the flux, and a conducting fluid is further operatively utilized connecting the membrane and the anode.

Accordingly the application of electric energy thereto reduces the MgO to magnesium while oxygen is vented at the anode. Simultaneously the carbon oxide(s) adjacent to the. cathode react with the magnesium to form MgO carbon monoxide and free carbon, all the while maintaining gas pressure within the chamber. The carbon monoxide is continuously recycled. The carbon may be collected periodically.

The molten alkali salt flux of such an embodiment may be selected from the group consisting of MgF and CaF and the molten alkali salt is maintained at a temperature in the vicinity of 900° C.

Likewise, it has been discovered according to the inventive aspects hereof that an SOM process might be creatively adaptable for direct reduction of carbon dioxide to carbon provided that a suitable flux could be found. The flux would be required to dissolve carbon dioxide within the favorable temperature range for the membrane utilized.

After conducting a considerable search for such a solvent flux, suitable examples have been discovered. For example, see, Elzo Sada, Shigio Katoh, et al., Al. Journal of Chemical & Engineering Data 26, pages 279-281 (1981).

The SOM process as applied to the electrolytic reduction of carbon dioxide provides a very much simpler, if not the simplest process, for obtaining carbon from carbon dioxide, inasmuch as the reduction of carbon dioxide to carbon leaves no intermediate metallic oxide ash to be reduced in turn.

Also the direct reduction of carbon dioxide is more efficient because there is no intermediate exothermic process, and thus no partial energy recovery by thermal engines is needed, and moreover, separation of ash from product carbon is unnecessary.

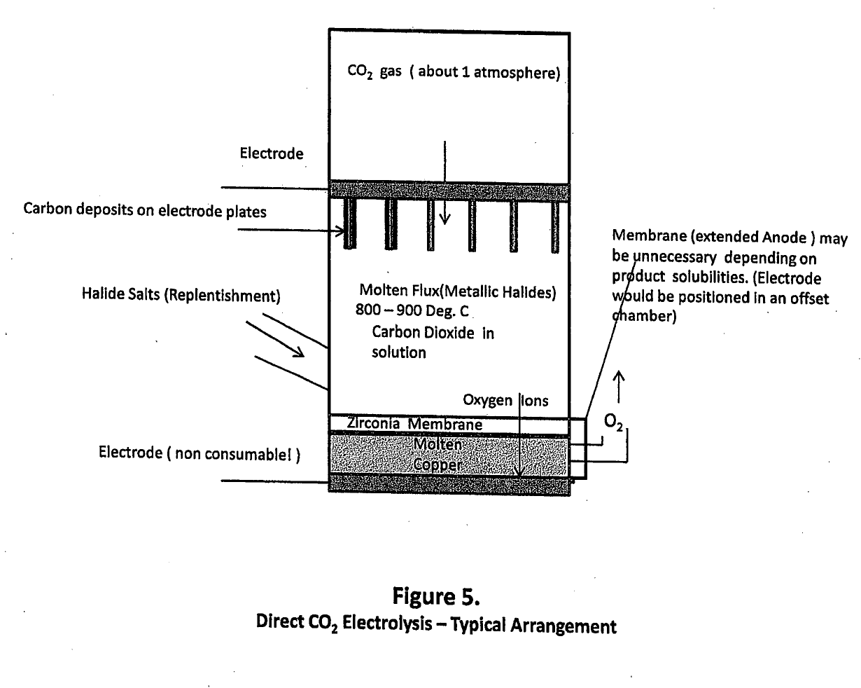

This provides motivation for the second preferred embodiment of the present invention, an example of which is illustrated in FIG. 5.

Carbon dioxide is separated from the atmosphere and thereafter charged into the reaction chamber. A flux is provided comprising at least one molten alkali salt, in which the carbon dioxide is soluble. Thereafter the carbon dioxide is dissolved in the flux.

A cathode is provided which is immersed in the flux and a non consumable anode is placed in communication with the flux. A membrane is disposed in contact with the flux for transporting oxygen ions to the anode. A conducting fluid preferably, comprising a molten metal, such for example molten copper, is provided for operatively connecting the membrane and the anode.

Whereupon electrical energy is applied thereto in order to reduce the carbon dioxide into carbon and oxygen, and thereafter the carbon produced thereby may be collected.

Having thus described exemplary embodiments of the present invention, it should be noted by those skilled in the art, that the within disclosures are exemplary only and that various other alternatives, adaptations, and modifications may be made within the scope and spirit of the present invention. Accordingly, the present invention is not limited to the specific embodiments as illustrated herein, but is only limited by the following claims.

What is claimed is, at least:

1. A method for reducing atmospheric carbon dioxide and for producing carbon therefrom, said method comprising the steps of:
maintaining the pressure to 1-10 atmospheres;
separating carbon dioxide from the atmosphere;
providing a flux comprising at least one molten alkali salt, and into which carbon dioxide is dissolvable, and into which free oxygen is not substantially dissolvable;
dissolving the carbon dioxide into the flux;
providing a cathode and immersing the cathode into the flux;
providing a non-consumable anode in communication with the flux;
applying electrical energy thereto to reduce the carbon dioxide into carbon and oxygen; and
collecting the carbon produced thereby.

2. The method for reducing atmospheric carbon dioxide and for producing carbon therefrom claim 1, and wherein said molten alkali salt flux is selected from the group consisting of potassium chloride, sodium chloride, and mixtures thereof.

3. The method for reducing atmospheric carbon dioxide and for producing carbon therefrom of claim 1 further comprising collecting oxygen at the anode.

4. The method for reducing atmospheric carbon dioxide and for producing carbon therefrom of claim 1 further comprising venting oxygen therefrom.

5. A method for reducing atmospheric carbon dioxide and for producing carbon therefrom, said method comprising the steps of:
separating carbon dioxide from the atmosphere and charging the carbon dioxide to the chamber;
providing a flux comprising at least one molten alkali salt, and into which carbon dioxide is dissolvable, and into which free oxygen may be substantially dissolvable;
dissolving the carbon dioxide into the flux;
providing a cathode and immersing the cathode into the flux;
providing a non-consumable anode in communication with the flux;
providing a membrane disposed in contact with the flux for transporting oxygen ions to the anode;
providing a conducting fluid for operatively connecting the membrane and the anode;
applying electrical energy thereto to reduce the carbon dioxide into carbon and oxygen; and
collecting the carbon produced thereby.

6. The method for reducing atmospheric carbon dioxide and for producing carbon therefrom of claim 5, and wherein said molten alkali salt flux is selected from the group consisting of potassium chloride, sodium chloride, and mixtures thereof.

7. The method for reducing atmospheric carbon dioxide and for producing carbon therefrom of claim 5, and wherein said membrane disposed in contact with the flux comprises zirconium oxide.

8. The method for reducing atmospheric carbon dioxide and for producing carbon therefrom of claim 7 additionally comprising reinforcement of such membrane with ytterbium.

9. The method for reducing atmospheric carbon dioxide and for producing carbon therefrom of claim 7, and wherein the zirconium oxide is substantially pure.

10. The method for reducing atmospheric carbon dioxide and for producing carbon therefrom of claim 20, and wherein said conducting fluid comprises a molten metal.

11. The method for reducing atmospheric carbon dioxide and for producing carbon therefrom of claim 5, and wherein the molten metal comprises molten copper.

12. The method for reducing atmospheric carbon dioxide and for producing carbon therefrom, said method comprising the steps of:
providing a pressurable chamber maintained at a pressure of greater than 1 atmosphere;
separating carbon dioxide from the atmosphere;
providing within the chamber a flux comprising at least one molten alkali salt;
collecting and maintaining carbon oxides from the group consisting of the collected carbon dioxide together with the carbon monoxide produced hereby in contact therewith;
providing a renewable source of magnesium oxide;
dissolving the magnesium oxide into the molten flux;
providing a cathode and contacting the cathode with the flux;
forming magnesium metal at the cathode;
reacting adjacent the cathode the carbon oxide with the magnesium to form carbon monoxide and free carbon while maintaining gas pressure upon the chamber;
providing a non-consumable anode in communication with the flux;
providing a membrane disposed in communication with the flux;
providing a conducting fluid for operatively connecting the membrane and the anode;
applying electrical energy thereto to reduce the carbon dioxide into carbon and oxygen;
venting oxygen from the chamber; and collecting the carbon produced thereby.

13. The method for reducing atmospheric carbon dioxide and for producing carbon therefrom of claim 12, and wherein said molten alkali salt flux is selected from the group consisting of MgF and CaF.

14. The method for reducing atmospheric carbon dioxide and for producing carbon therefrom of claim 12, and wherein said molten alkali salt flux is maintained at approximately 1100 degrees C.

15. The method for reducing atmospheric carbon dioxide and for producing carbon therefrom of claim 12, and wherein the conducting fluid comprises magnesium oxide dissolved in the flux.

16. The method for reducing atmospheric carbon dioxide and for producing carbon therefrom of claim 12, and wherein the collected carbon oxides are disposed above the flux.

17. The method for reducing atmospheric carbon dioxide and for producing carbon therefrom according to either of claim 1, 5 or 12, wherein said electrical energy further utilizes solar power.

18. The method for reducing atmospheric carbon dioxide and for producing carbon therefrom according to claim 1, 5 or 12, wherein said electrical energy further utilizes geothermal power.

19. The method for reducing atmospheric carbon dioxide and for producing carbon therefrom according to claim 1, 5 or 12, wherein said electrical energy further utilizes wind power.

20. The method for reducing atmospheric carbon dioxide and for producing carbon therefrom of claim 1, 5 or 12, and further comprising the step of production of carbonaceous fuel therefrom.

21. The method for reducing atmospheric carbon dioxide and for producing carbon therefrom of claim 20 and further including utilization of a catalyzed chemical reaction in which carbon monoxide and hydrogen are converted into hydrocarbons.

22. The method for reducing atmospheric carbon dioxide and for producing carbon therefrom of claim 21, and wherein said catalyzed chemical reaction comprises the Fischer-Tropsch process.

23. The method for reducing atmospheric carbon dioxide and for producing carbon therefrom of claim 12, and further comprising the step of recovering magnesium metal therefrom.
